(19) United States
(12) Patent Application Publication
(10) Pub. No.: US 2026/0180313 A1
(43) Pub. Date: Jun. 25, 2026

(54) SHORT-CIRCUIT PROTECTION SYSTEM

(71) Applicant: QISDA CORPORATION, Taoyuan City (TW)

(72) Inventors: Meng-Hsien Lin, Taoyuan City (TW); Han-Wen Liu, Taoyuan City (TW)

(73) Assignee: QISDA CORPORATION, Taoyuan City (TW)

(21) Appl. No.: 19/359,728

(22) Filed: Oct. 16, 2025

(30) Foreign Application Priority Data
Dec. 25, 2024 (CN) 202411929991.1

(51) Int. Cl. H02H 7/20; H02H 1/00; H02H 1/06

(52) U.S. Cl. CPC H02H 7/20; H02H 1/0007; H02H 1/063

(57) ABSTRACT

A short circuit protection system includes a first short circuit protection circuit, a second short circuit protection circuit and an antenna status detection circuit implemented only by hardware. The first short circuit protection circuit is configured to provide short-to-power protection between an antenna and a component. The second short circuit protection circuit is configured to provide short-to-ground protection between the antenna and the component. The antenna status detection circuit is configured to detect the operational status of the antenna.

### BACKGROUND OF THE INVENTION

### 1. Field of the Invention

The present invention is related to a short-circuit protection system, and more particularly, to a short circuit protection system capable of providing real-time monitoring and protection for vehicle antennas.

### 2. Description of the Prior Art

As the consumer demand for in-vehicle infotainment systems (IVI systems) increases, most automotive equipment includes vehicle antennas, radios, car phones, navigation systems, and satellite radios. The main function of the vehicle antenna is to receive radio waves for transmission to radios, car phones and receivers of the navigation system. If the vehicle antenna is short-circuited and/or open-circuited, it may not be able to operate normally, wherein the overvoltage or overcurrent caused by the short-circuited antenna may damage other components.

In prior-art technologies, it is common to dispose a microprocessor-controlled protection circuit between the vehicle antenna and other components. The microprocessor monitors the current and voltage conditions in the system through the sensor on a real time basis, and switches the switching components in the protection circuit from the on-state to the cut-off state when the input voltage exceeds a pre-set safety threshold, thereby cutting off the path from the overvoltage/overcurrent to the load components to provide protection.

The prior-art short-circuit protection system involves the operation of microprocessors, software and hardware, and the complexity of system integration is high. In addition, the microprocessor needs to be kept active, which increases the cost and dark current, and the processing time of the software must be increased. Therefore, a short-circuit protection system that can provide real-time monitoring and protection of vehicle antennas is required.

### SUMMARY OF THE INVENTION

The present invention provides a short-circuit protection system for providing short-circuit protection between an antenna and a component. A first short-circuit protection circuit in the short-circuit protection system includes a first transistor, a second transistor and a third transistor. The first transistor includes a first terminal, a second terminal coupled to a ground potential, and a control terminal coupled to the antenna. The second transistor includes a first terminal coupled to the antenna, a second terminal, and a control terminal coupled to the first terminal of the first transistor. The third transistor includes a first terminal coupled to the antenna, a second terminal coupled to the component, and a control terminal coupled to the second terminal of the second transistor.

Preferably, the first transistor is turned on when the antenna short-circuited to a positive voltage causes an overvoltage on the control terminal of the first transistor, the first terminal of the second transistor and the first terminal of the third transistor; the second transistor is turned on when the turned-on first transistor transmits energy associated with the overvoltage to the control terminal of the second transistor; and the third transistor is turned off when the turned-on second transistor transmits the energy associated with the overvoltage to the control terminal of the third transistor, thereby cutting off energy transfer path from the overvoltage to the component.

Preferably, the first transistor is an NPN-type bipolar junction transistor, and each of the second transistor and the third transistor is a P-channel metal-oxide-semiconductor field-effect transistor.

Preferably, the short-circuit protection system further includes a second short-circuit protection circuit. The second short-circuit protection circuit includes a fourth transistor, a fifth transistor, a sixth transistor, a seventh transistor, a Schottky diode, a first power source and a second power source. The fourth transistor includes a first terminal, a second terminal coupled to the ground potential, and a control terminal. The fifth transistor includes a first terminal, a second terminal coupled to the ground potential, and a control terminal coupled to the first terminal of the fourth transistor. The sixth transistor includes a first terminal, a second terminal coupled to the ground potential, and a control terminal coupled to the first terminal of the fifth transistor. The seventh transistor includes a first terminal coupled to the antenna, a second terminal coupled to the component, and a control terminal coupled to the first terminal of the sixth transistor. The Schottky diode includes an anode coupled to the control terminal of the fourth transistor, and a cathode coupled to the antenna. The first power source is configured to provide a positive voltage to the control terminal of the fourth transistor. The second power source is configured to provide the positive voltage to the control terminal of the fifth transistor.

Preferably, when the antenna short-circuited to the ground potential causes an overcurrent, the second terminal of the fourth transistor is pulled to the ground voltage to cut off the fourth transistor; when the fourth transistor is cut off, the second power source provides the positive voltage at the control terminal of the fifth transistor, so as to turn on the fifth transistor; the sixth transistor is cut off when the control terminal of the sixth transistor is pulled to the ground potential via the turned-on fifth transistor; when the sixth transistor is cut off, voltage difference between the control terminal and the second terminal of the seventh transistor does not satisfy a trigger condition, and the seventh transistor is cut off, thereby cutting off energy transfer path between the overcurrent and the component.

Preferably, each of the fourth transistor, the fifth transistor and the sixth transistor is an NPN-type bipolar junction transistor; and the seventh transistor is a PNP-type bipolar junction transistor.

Preferably, the short-circuit protection system further includes an antenna status detection circuit and a global navigation satellite system module. The antenna status detection circuit includes a current mirror and an eighth transistor. The current mirror is configured to detect current flowing through the component for providing a detection voltage. The eighth transistor includes a first terminal coupled to a first potential different from the ground potential; a second terminal coupled to the ground potential; and a control terminal coupled to the current mirror for receiving the detection voltage. The global navigation satellite system module is coupled to the first terminal of the eighth transistor and configured to detect an operational status of the antenna based on potential at the first terminal of the eighth transistor.

Preferably, the eighth transistor is an NPN-type bipolar junction transistor.

Preferably, a ninth transistor of the current mirror includes a first terminal coupled to the ground potential; a second terminal coupled to a first end of the antenna; and a control terminal. A tenth transistor of the current mirror includes a first terminal for outputting the detection voltage, a second terminal coupled to a second end of the antenna, and a control terminal coupled to the control terminal of the ninth transistor.

Preferably, each of the ninth transistor and the tenth transistor is a PNP-type bipolar junction transistor.

Preferably, when the antenna is able to function normally, the eighth transistor is cut off by the detection voltage provided by the current mirror, thereby maintaining the first terminal of the eighth transistor at the first potential.

Preferably, the antenna status detection circuit is configured to determine that the antenna is able to function normally when detecting that the first terminal of the eighth transistor is at the first potential.

Preferably, when the antenna is short-circuited to a positive voltage and the ground potential, the eighth transistor is turned on by the detection voltage provided by the current mirror, thereby pulling the first terminal of the eighth transistor to the ground potential.

Preferably, the antenna status detection circuit is configured to determine that the antenna is unable to function normally when detecting that the first terminal of the eighth transistor is at the ground potential.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a short-circuit protection system according to an embodiment of the present invention.

FIG. 2 is a schematic diagram illustrating an implementation of a first short-circuit protection circuit in a short-circuit protection system according to an embodiment of the present invention.

FIG. 3 is a schematic diagram illustrating an implementation of a second short-circuit protection circuit in a short-circuit protection system according to an embodiment of the present invention.

FIG. 4 is a schematic diagram illustrating an implementation of an antenna status detection circuit in a short-circuit protection system according to an embodiment of the present invention.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

Certain terms are used throughout the description and following claims to refer to particular elements. As one skilled in the art will understand, electronic equipment manufacturers may refer to an element by different names. This document does not intend to distinguish between elements that differ in name but not function. It will be understood that when the terms “include”, “comprise” and/or “have” are used in the description of the present disclosure, it indicates that the existence of the corresponding features, areas/regions, steps, operations and/or components, without excluding the existence or addition of one or a plurality of other features, areas/regions, steps, operations and/or components.

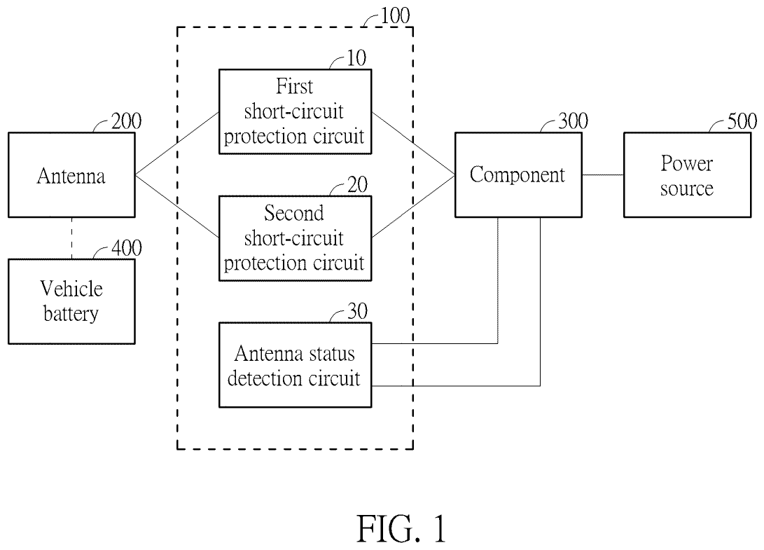

FIG. 1 is a functional block diagram illustrating a short-circuit protection system 100 according to an embodiment of the present invention. The short-circuit protection system 100 is configured to provide short-circuit protection between an antenna 200 and a component 300, wherein the power required for operating the antenna 200 and the component 300 are supplied by a power source 500. In an embodiment, the power source 500 is configured to provide 5V voltage for operating the antenna 200 and the component 300, and the operation of the power source 500 is supplied, for example, by stepping down a voltage of a vehicle battery 400 using a low-dropout regulator (LDO) (not shown in FIG. 1), wherein the voltage range of the vehicle battery 400 is, for example, 9V-16V. However, the implementation of the vehicle battery 400 and the power source 500 does not limit the scope of the present invention. Since the voltage of the vehicle battery 400 is higher than that of the power source 500, if the vehicle battery 400 or another high-voltage power source is abnormally short-circuited to the antenna 200 (as depicted by the dotted line in FIG. 1), the short-circuit protection system 100 is able to prevent high voltage surge of the short-circuited antenna 200 from directly affecting the component 300 or from damaging the component 300.

The short-circuit protection system 100 includes a first short-circuit protection circuit 10, a second short-circuit protection circuit 20, and an antenna status detection circuit 30. When the antenna 200 is abnormally coupled to the vehicle battery 400, the first short-circuit protection circuit 10 can provide short-to-battery protection to the component 300. When the antenna 200 is abnormally coupled to a ground potential, the second short-circuit protection circuit 20 can provide short-to-ground protection to the component 300. The antenna status detection circuit 30 is configured to detect the operational status of the antenna 200.

In the embodiment of the present invention, the antenna 200 may be a vehicle antenna, and the component 300 may be a switch in an antenna diagnostic circuit, but is not limited thereto.

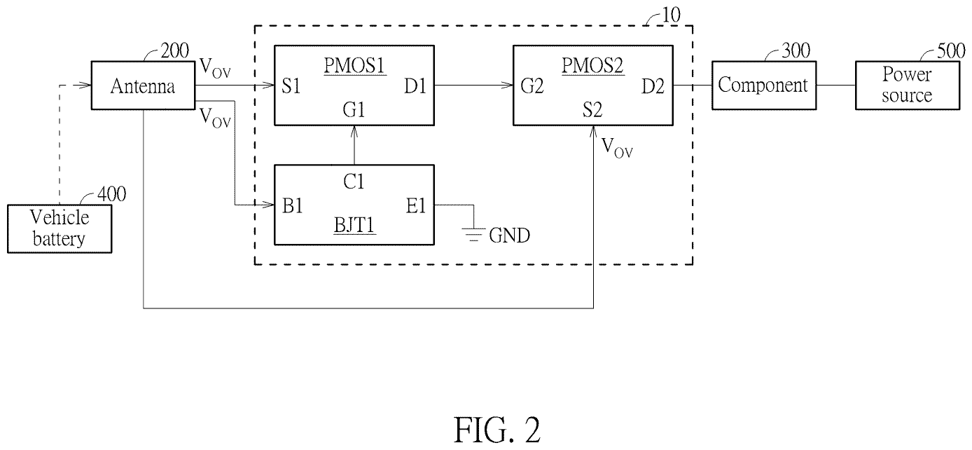

FIG. 2 is a schematic diagram illustrating an implementation of the first short-circuit protection circuit 10 in the short-circuit protection system 100 according to an embodiment of the present invention. For the sake of simplification, FIG. 2 only shows the details related to the first short-circuit protection circuit 10 in the short-circuit protection system 100. The first short-circuit protection circuit 10 includes a first transistor BJT1, a second transistor PMOS1, and a third transistor PMOS2. The first transistor BJT1 includes a first terminal C1 coupled to the second transistor PMOS1, a second terminal E1 coupled to a ground potential GND, and a control terminal B1 coupled to the antenna 200. The second transistor PMOS1 includes a first terminal S1 coupled to the antenna 200, a second terminal D1 coupled to the third transistor PMOS2, and a control terminal G1 coupled to the first terminal C1 of the first transistor BJT1. The third transistor PMOS2 includes a first terminal S2 coupled to the antenna 200, a second terminal D2 coupled to the component 300, and a control terminal G2 coupled to the second terminal D1 of the second transistor PMOS1.

In the present invention, when the potential relationship between the first terminal C1, the second terminal E1 and the control terminal B1 of the first transistor BJT1 satisfies a first trigger condition, the first transistor BJT1 is turned on (i.e., the first terminal C1 is electrically connected to the second terminal E1); when the potential relationship between the first terminal C1, the second terminal E1 and the control terminal B1 of the first transistor BJT1 does not satisfy the first trigger condition, the first transistor BJT1 is cut off (i.e., the first terminal C1 is electrically isolated from the second terminal E1). In an embodiment of the present invention, the first transistor BJT1 is an NPN-type bipolar junction transistor (BJT), wherein the first terminal C1, the second terminal E1 and the control terminal B1 are respectively a collector, an emitter and a base, V_{BE1} represents the voltage difference between the control terminal B1 and the second terminal E1 of the first transistor BJT1, and V_{BC1} represents the voltage difference between the control terminal B1 and the first terminal C1 of the first transistor BJT1. When V_{BE1} and V_{BC1} are both forward-biased, the first transistor BJT1 is configured to operate in the saturation region. When V_{BE1} is forward-biased and V_{BC1} is reverse-biased, the first transistor BJT1 is configured to operate in the active region. When V_{BE1} and V_{BC1} are both reverse-biased, the first transistor BJT1 is configured to operate in the cut-off region. That is, when the voltage difference V_{BE1} between the control terminal B1 and the second terminal E1 of the first transistor BJT1 is forward-biased, the first transistor BJT1 is turned on since the first trigger condition is satisfied; when the voltage difference V_{BE1} between the control terminal B1 and the second terminal E1 of the first transistor BJT1 is reversed-biased, the first transistor BJT1 is cut off since the first trigger condition is not satisfied.

In the present invention, when the potential relationship between the first terminal S1, the second terminal D1 and the control terminal G1 of the second transistor PMOS1 satisfies the second trigger condition, the second crystal PMOS1 is turned on (the first terminal S1 is electrically connected to the second terminal D1); when the potential relationship between the first terminal S1, the second terminal D1 and the control terminal G1 of the second transistor PMOS1 does not satisfy the second trigger condition, the second transistor PMOS1 is cut off (the first terminal S1 is electrically isolated from the second terminal D1). In an embodiment of the present invention, the second transistor PMOS1 is a P-channel metal-oxide-semiconductor field-effect transistor (PMOSFET), wherein the first terminal S1, the second terminal D1 and the control terminal G1 are respectively a source, a drain and a gate, V_{GS1} represents the voltage difference between the control terminal G1 and the first terminal S1 of the second transistor PMOS1, V_{DS1} represents the voltage difference between the second terminal D1 and the first terminal S1 of the second transistor PMOS1, and V_{TH1} represents the threshold voltage of the second transistor PMOS1. When |V_{GS1}|≥|V_{TH1}| and |V_{DS1}|>|V_{GS1}|-|V_{TH1}|, the second transistor PMOS1 is configured to operate in the saturation region; when |V_{GS1}|≥|V_{TH1}| and |V_{DS1}|≤|V_{GS1}|<|V_{TH1}|, the second transistor PMOS1 is configured to operate in the linear region; when |V_{GS1}|<|V_{TH1}|, the second transistor PMOS1 is configured to operate in the cut-off region. That is, when the absolute value of the voltage difference V_{GS1} between the control terminal G1 and the first terminal S1 of the second transistor PMOS1 is not smaller than the absolute value of its threshold voltage V_{TH1}, the second transistor PMOS1 is turned on since the second trigger condition is satisfied; when the absolute value of the voltage difference V_{GS1} between the control terminal G1 and the first terminal S1 of the second transistor PMOS1 is smaller than the absolute value of its threshold voltage V_{TH1}, the second transistor PMOS1 is cut off since the second trigger condition is not satisfied.

In the present invention, when the potential relationship between the first terminal S2, the second terminal D2 and the control terminal G2 of the third transistor PMOS2 satisfies the third trigger condition, the third transistor PMOS2 is turned on (the first terminal S2 is electrically connected to the second terminal D2); when the potential relationship between the first terminal S2, the second terminal D2 and the control terminal G2 of the third transistor PMOS2 does not satisfy the third trigger condition, the third transistor PMOS2 is cut off (the first terminal S2 is electrically isolated from the second terminal D2). In an embodiment of the present invention, the third transistor PMOS2 is a P-channel metal-oxide-semiconductor field-effect transistor, wherein the first terminal S2, the second terminal D2 and the control terminal G2 are respectively a source, a drain and a gate, V_{GS2} represents the voltage difference between the control terminal G2 and the first terminal S2 of the third transistor PMOS2, V_{DS2} represents the voltage difference between the second terminal D2 and the first terminal S2 of the third transistor PMOS2, and V_{TH2} represents the threshold voltage of the third transistor PMOS2. When |V_{GS2}|≥|V_{TH2}| and |V_{DS2}|>|V_{GS2}|-|V_{TH2}|, the third transistor PMOS2 is configured to operate in the saturation region; when |V_{GS2}|≥|V_{TH2}| and |V_{DS2}|≤|V_{GS2}|-|V_{TH2}|, the third transistor PMOS2 is configured to operate in the linear region; when |V_{GS2}|<|V_{TH2}|, the third transistor PMOS2 is configured to operate in the cut-off region. That is, when the absolute value of the voltage difference V_{GS2} between the control terminal G2 and the first terminal S2 of the third transistor PMOS2 is not smaller than the absolute value of its threshold voltage V_{TH2}, the third transistor PMOS2 is turned on since the third trigger condition is satisfied; when the absolute value of the voltage difference V_{GS2} between the control terminal G2 and the first terminal S1 of the second transistor PMOS1 is smaller than the absolute value of its threshold voltage V_{TH2}, the third transistor PMOS2 is cut off since the third trigger condition is not satisfied.

Next, the operation of the first short-circuit protection circuit 10 is illustrated. If the antenna 200 is abnormally coupled to the vehicle battery 400 and thus causes a short-to-power condition (as depicted by the dotted arrow in FIG. 2), the positive voltage supplied by the vehicle battery 400 results in an overvoltage V_{OV} at the control terminal B1 of the first transistor BJT1, the first terminal S1 of the second transistor PMOS1 and the first terminal S2 of the third transistor PMOS2. Under such circumstance, in the first short-circuit protection circuit 10, the first transistor BJT1 is turned on since the first trigger condition is satisfied, the second transistor PMOS1 is turned on since the second trigger condition is satisfied, and the third transistor PMOS2 is cut off since the third trigger condition is not satisfied, thereby providing short-circuit protection between the component 300 and the overvoltage V_{OV}. For illustrative purposes, it is assumed that the first transistor BJT1 is an NPN-type BJT, the second transistor PMOS1 is a PMOSFET, and the third transistor PMOS2 is a PMOSFET. When the control terminal B1 of the first transistor BJT1 is pulled up to a high potential by the overvoltage V_{OV}, V_{BE1} is forward-biased, and the first transistor BJT1 is thus turned on. When the first terminal S1 of the second transistor PMOS1 is pulled up to a high potential by the overvoltage V_{OV}, and the control terminal G1 of the second transistor PMOS1 is pulled down to the ground potential GND by the turned-on first transistor BJT1, the absolute value of V_{GS1} is greater than the absolute value of its threshold voltage V_{TH1}, and the second transistor PMOS1 is thus turned on. When the first terminal S2 of the third transistor PMOS2 is pulled up to a high potential by the overvoltage V_{OV}, and the control terminal G2 of the second transistor PMOS1 is pulled up to the high potential of the overvoltage V_{OV} by the turned-on second transistor PMOS1, the absolute value of V_{GS2} is not greater than the absolute value of its threshold voltage V_{TH2}, and the third transistor PMOS2 is thus cut off, thereby cutting off the energy transfer path from the overvoltage V_{OV} to the component 300. Therefore, the first short-circuit protection circuit 10 can provide short-circuit protection to the component 300 for preventing to overvoltage V_{OV} from damaging the component 300.

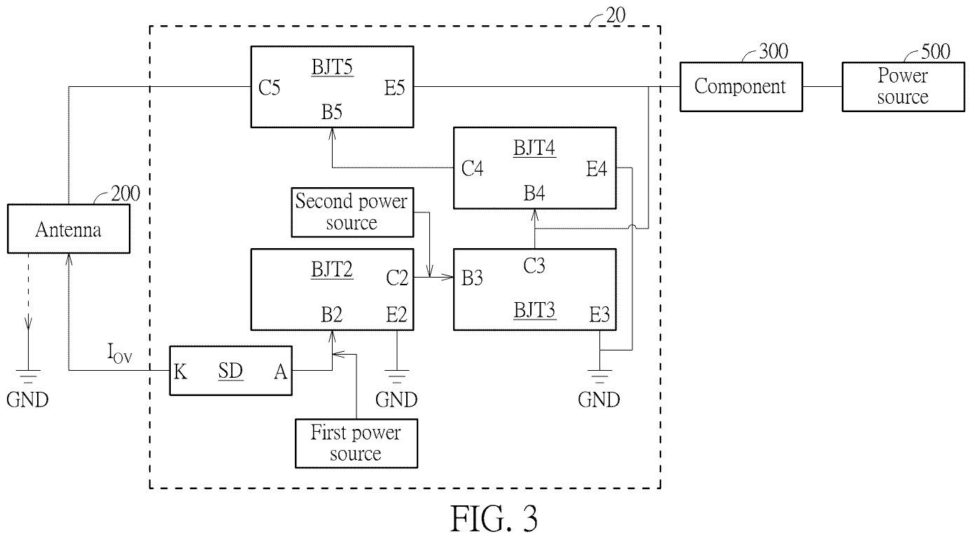

FIG. 3 is a schematic diagram illustrating an implementation of the second short-circuit protection circuit 20 in the short-circuit protection system 100 according to an embodiment of the present invention. For the sake of simplification, FIG. 3 only shows the details related to the second short-circuit protection circuit 20 in the short-circuit protection system 100. The second short-circuit protection circuit 20 includes a fourth transistor BJT2, a fifth transistor BJT3, a sixth transistor BJT4, a seventh transistor BJT5 and a Schottky diode SD. The fourth transistor BJT2 includes a first terminal C2 coupled to the control terminal B3 of the fifth transistor BJT3, a second terminal E2 coupled to the ground potential GND, and a control terminal B2 is coupled to the anode of the Schottky diode SD. The fifth transistor BJT3 includes a first terminal C3 coupled to the control terminal B4 of the sixth transistor BJT4, a second terminal E3 coupled to the ground potential GND, and a control terminal B3 is coupled to the first terminal C2 of the fourth transistor BJT2. The sixth transistor BJT4 includes a first terminal C4 coupled to the control terminal B5 of the seventh transistor BJT5, a second terminal E4 coupled to the ground potential GND, and a control terminal B4 coupled to the first terminal C3 of the fifth transistor BJT3. The seventh transistor BJT5 includes a first terminal C5 coupled to the antenna 200, a second terminal E5 coupled to the component 300, and a control terminal B5 coupled to the first terminal C4 of the sixth transistor BJT4. The anode A of the Schottky diode SD is coupled to the control terminal B2 of the fourth transistor BJT2, and the cathode K of the Schottky diode SD is coupled to the antenna 200. The first power source provides a positive voltage (e.g., 3.3V) at the control terminal B2 of the fourth transistor BJT2. The second power source provides a positive voltage (e.g., 3.3V) at the control terminal B3 of the fifth transistor BJT3.

In the present invention, when the potential relationship between the first terminal C2, the second terminal E2 and the control terminal B2 of the fourth transistor BJT2 satisfies a fourth trigger condition, the fourth transistor BJT2 is turned on (i.e., the first terminal C2 is electrically connected to the second terminal E2); when the potential relationship between the first terminal C2, the second terminal E2 and the control terminal B2 of the fourth transistor BJT2 does not satisfy the fourth trigger condition, the fourth transistor BJT2 is turned off (i.e., the first terminal C2 is electrically isolated from the second terminal E2). In an embodiment of the present invention, the fourth transistor BJT2 is an NPN-type BJT, wherein the first terminal C2, the second terminal E2 and the control terminal B2 are respectively a collector, an emitter and a base, V_{BE2} represents the voltage difference between the control terminal B2 and the second terminal E2 of the fourth transistor BJT2, and V_{BC2} represents the voltage difference between the control terminal B2 and the first terminal C2 of the fourth transistor BJT2. When V_{BE2} and V_{BC2} are both forward-biased, the fourth transistor BJT2 is configured to operate in the saturation region. When V_{BE2} is forward-biased and V_{BC2} is reverse-biased, the fourth transistor BJT2 is configured to operate in the active region. When V_{BE2} and V_{BC2} are both reverse-biased, the fourth transistor BJT2 is configured to operate in the cut-off region. That is, when the voltage difference V_{BE2} between the control terminal B2 and the second terminal E2 of the fourth transistor BJT2 is forward-biased, the fourth transistor BJT2 is turned on since the fourth trigger condition is satisfied; when the voltage difference V_{BE2} between the control terminal B2 and the second terminal E2 of the fourth transistor BJT2 is reversed-biased, the fourth transistor BJT2 is cut off since the fourth trigger condition is not satisfied.

In the present invention, when the potential relationship between the first terminal C3, the second terminal E3 and the control terminal B3 of the fifth transistor BJT3 satisfies a fifth trigger condition, the fifth transistor BJT3 is turned on (i.e., the first terminal C3 is electrically connected to the second terminal E3); when the potential relationship between the first terminal C3, the second terminal E3 and the control terminal B3 of the fifth transistor BJT3 does not satisfy the fifth trigger condition, the fifth transistor BJT3 is turned off (i.e., the first terminal C3 is electrically isolated from the second terminal E3). In an embodiment of the present invention, the fifth transistor BJT3 is an NPN-type BJT, wherein the first terminal C3, the second terminal E3 and the control terminal B3 are respectively a collector, an emitter and a base, V_{BE3} represents the voltage difference between the control terminal B3 and the second terminal E3 of the fifth transistor BJT3, and V_{BC3} represents the voltage difference between the control terminal B3 and the first terminal C3 of the fifth transistor BJT3. When V_{BE3} and V_{BC3} are both forward-biased, the fifth transistor BJT3 is configured to operate in the saturation region. When V_{BE3} is forward-biased and V_{BC3} is reverse-biased, the fifth transistor BJT3 is configured to operate in the active region. When V_{BE3} and V_{BC3} are both reverse-biased, the fifth transistor BJT3 is configured to operate in the cut-off region. That is, when the voltage difference V_{BE3} between the control terminal B3 and the second terminal E3 of the fifth transistor BJT3 is forward-biased, the fifth transistor BJT3 is turned on since the fifth trigger condition is satisfied; when the voltage difference V_{BE2} between the control terminal B3 and the second terminal E3 of the fifth transistor BJT3 is reversed-biased, the fifth transistor BJT3 is cut off since the fifth trigger condition is not satisfied.

In the present invention, when the potential relationship between the first terminal C4, the second terminal E4 and the control terminal B4 of the sixth transistor BJT4 satisfies a sixth trigger condition, the sixth transistor BJT4 is turned on (i.e., the first terminal C4 is electrically connected to the second terminal E4); when the potential relationship between the first terminal C4, the second terminal E4 and the control terminal B4 of the sixth transistor BJT4 does not satisfy the sixth trigger condition, the sixth transistor BJT4 is turned off (i.e., the first terminal C4 is electrically isolated from the second terminal E4). In an embodiment of the present invention, the sixth transistor BJT4 is an NPN-type BJT, wherein the first terminal C4, the second terminal E4 and the control terminal B4 are respectively a collector, an emitter and a base, V_{BE4} represents the voltage difference between the control terminal B4 and the second terminal E4 of the sixth transistor BJT4, and V_{BC4} represents the voltage difference between the control terminal B4 and the first terminal C4 of the sixth transistor BJT4. When V_{BE4} and V_{BC4} are both forward-biased, the sixth transistor BJT4 is configured to operate in the saturation region. When V_{BE4} is forward-biased and V_{BC4} is reverse-biased, the sixth transistor BJT4 is configured to operate in the active region. When V_{BE4} and V_{BC4} are both reverse-biased, the sixth transistor BJT4 is configured to operate in the cut-off region. That is, when the voltage difference V_{BE4} between the control terminal B4 and the second terminal E4 of the sixth transistor BJT4 is forward-biased, the sixth transistor BJT4 is turned on since the sixth trigger condition is satisfied; when the voltage difference V_{BE2} between the control terminal B4 and the second terminal E4 of the sixth transistor BJT4 is reversed-biased, the sixth transistor BJT4 is cut off since the sixth trigger condition is not satisfied.

In the present invention, when the potential relationship between the first terminal C5, the second terminal E5 and the control terminal B5 of the seventh transistor BJT5 satisfies a seventh trigger condition, the seventh transistor BJT5 is turned on (i.e., the first terminal C5 is electrically connected to the second terminal E5); when the potential relationship between the first terminal C5, the second terminal E5 and the control terminal B5 of the seventh transistor BJT5 does not satisfy the seventh trigger condition, the seventh transistor BJT5 is turned off (i.e., the first terminal C5 is electrically isolated from the second terminal E5). In an embodiment of the present invention, the seventh transistor BJT5 is an PNP-type BJT, wherein the first terminal C5, the second terminal E5 and the control terminal B5 are respectively a collector, an emitter and a base, V_{EB5} represents the voltage difference between the second terminal E5 and the control terminal B5 of the seventh transistor BJT5, and V_{CB5} represents the voltage difference between the first terminal C5 and the control terminal B5 of the seventh transistor BJT5. When V_{EB5} and V_{CB5} are both forward-biased, the seventh transistor BJT5 is configured to operate in the saturation region. When V_{EB5} is forward-biased and V_{CB5} is reverse-biased, the seventh transistor BJT5 is configured to operate in the active region. When V_{EB5} and V_{CB5} are both reverse-biased, the seventh transistor BJT5 is configured to operate in the cut-off region. That is, when the voltage difference V_{EB5} between the second terminal E5 and the control terminal B5 of the seventh transistor BJT5 is forward-biased, the seventh transistor BJT5 is turned on since the seventh trigger condition is satisfied; when the voltage difference V_{BE2} between the second terminal E5 and the control terminal B5 of the seventh transistor BJT5 is reversed-biased, the seventh transistor BJT5 is cut off since the seventh trigger condition is not satisfied.

Next, the operation of the second short-circuit protection circuit 20 is illustrated. If the antenna 200 is abnormally coupled to the ground potential GND, the short-to-ground situation results in sudden overcurrent I_{OV} (as depicted by the dotted arrow in FIG. 3). Under such circumstance, if the sudden overcurrent I_{OV} is able to flow to the component 300 via the seventh transistor BJT5, it may damage the component 300, and the second short-circuit protection circuit 20 is thus required to protect the component 300. For illustrative purposes, it is assumed that each of the fourth transistor BJT2, the fifth transistor BJT3 and the sixth transistor BJT4 is an NPN-type BJT, and the seventh transistor BJT5 is a PNP-type BJT. Although the first power source supplies a positive voltage (such as 3.3V) at the second terminal B2 of the fourth transistor BJT2, the second terminal B2 of the fourth transistor BJT2 is forcibly pulled down to 0V of the ground potential GND when the antenna is shorted to the ground potential GND. Under such circumstance, no voltage difference is present between the control terminal B2 and the second terminal E2 of the fourth transistor BJT2, and the fourth transistor BJT2 is cut off since the fourth trigger condition is not satisfied. The second power source supplies a positive voltage (such as 3.3V) at the control terminal B2 of the fifth transistor BJT3, thereby establishing a voltage difference between the control terminal B3 and the second terminal E3 of the fifth transistor BJT3. Under such circumstance, the fifth transistor BJT3 is turned on since the fifth trigger condition is satisfied, and the control terminal G4 of the sixth transistor BJT4 is pulled down to the ground potential GND by the turned-on fifth transistor BJT3. With the fifth transistor BJT3 turned on, the control terminal B4 of the sixth transistor BJT4 is pulled down to 0V of the ground potential GND. Under such circumstance, no voltage difference is present between the control terminal B4 and the second terminal E4 of the sixth transistor BJT4, and the sixth transistor BJT4 is cut off since the sixth trigger condition is not satisfied. With the sixth transistor BJT4 cut off, the voltage difference between the control terminal B5 and the second terminal E5 of the seventh transistor BJT5 does not satisfy the seventh trigger condition. Therefore, the seventh transistor BJT5 is cut off, thereby cutting off the energy transfer path from the overcurrent I_{OV} to the component 300 for preventing the overcurrent I_{OV} from flowing through the component 300.

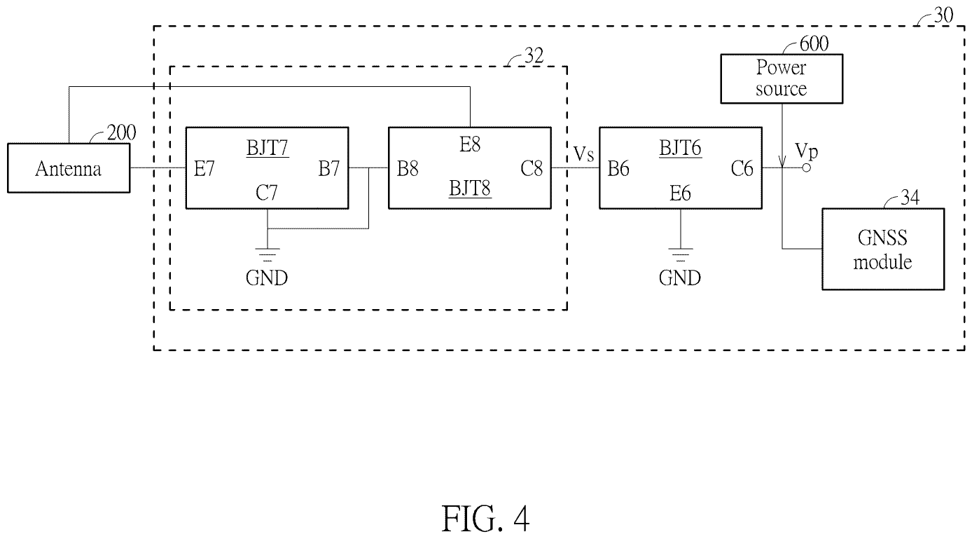

FIG. 4 is a schematic diagram illustrating an implementation of the antenna status detection circuit 30 in the short-circuit protection system 100 according to an embodiment of the present invention. For the sake of simplicity, FIG. 4 only shows the details related to the antenna status detection circuit 30 in the short-circuit protection system 100. The antenna status detection circuit 30 includes an eighth transistor BJT6, a current mirror 32, a global navigation satellite system (GNSS) module 34, and a power source 600. In an embodiment of the present invention, the power source 600 may be a 3.3V power supply capable of providing a first potential Vp. The eighth transistor BJT6 includes a first terminal C6 coupled to the GNSS module 34 and the first potential Vp, a second terminal E6 coupled to the ground potential GND, and a control terminal B6 coupled to the current mirror 32, wherein the first potential Vp (such as a positive potential of 3.3 V) differs from the ground potential GND (such as a low potential of 0 V). The current mirror 32 includes a ninth transistor BJT7 and a tenth transistor BJT8 configured to detect the current flowing through the component 300 (not shown in FIG. 4), thereby providing a corresponding detection voltage Vs to the eighth transistor BJT6. The ninth transistor BJT7 includes a first terminal C7 coupled to the ground potential GND, a second terminal E7 coupled to the first end of the antenna 200, and the control terminal B7 coupled to the tenth transistor BJT8. The tenth transistor BJT8 includes a first terminal C8 coupled to the eighth transistor BJT6 for providing the detection voltage Vs, a second terminal E8 is coupled to the second end of the antenna 200, and a control terminal B8 coupled to the control terminal B7 of the ninth transistor. In an embodiment of the present invention, each of the ninth transistor BJT7 and the tenth transistor BJT8 is a PNP-type BJT, but are not limited to this. The GNSS module 34 is coupled to the first terminal C6 of the eighth transistor BJT6, and is configured to detect the operational status of the antenna 200 based on the potential V_{C6} on the first terminal C6 of the eighth transistor BJT6.

In the present invention, when the potential relationship between the first terminal C6, the second terminal E6 and the control terminal B6 of the eighth transistor BJ6 satisfies an eighth trigger condition, the eighth transistor BJT6 is turned on (i.e., the first terminal C6 is electrically connected to the second terminal E6); when the potential relationship between the first terminal C6, the second terminal E6 and the control terminal B6 of the eighth transistor BJT6 does not satisfy the eighth trigger condition, the eighth transistor BJT6 is turned off (i.e., the first terminal C6 is electrically isolated from the second terminal E6). In an embodiment of the present invention, the eighth transistor BJT6 is an NPN-type BJT, wherein the first terminal C6, the second terminal E6 and the control terminal B6 are respectively a collector, an emitter and a base, V_{BE6} represents the voltage difference between the control terminal B6 and the second terminal E6 of the eighth transistor BJT6, and V_{BC6} represents the voltage difference between the control terminal B6 and the first terminal C6 of the eighth transistor BJT6. When V_{BE6} and V_{BC6} are both forward-biased, the eighth transistor BJT6 is configured to operate in the saturation region. When V_{BE6} is forward-biased and V_{BC6} is reverse-biased, the eighth transistor BJT6 is configured to operate in the active region. When V_{BE6} and V_{BC6} are both reverse-biased, the eighth transistor BJT6 is configured to operate in the cut-off region. That is, when the voltage difference V_{BE6} between the control terminal B6 and the second terminal E6 of the eighth transistor BJT6 is forward-biased, the eighth transistor BJT6 is turned on since the eighth trigger condition is satisfied; when the voltage difference V_{BE6} between the control terminal B6 and the second terminal E6 of the eighth transistor BJT6 is reversed-biased, the eighth transistor BJT3 is cut off since the eighth trigger condition is not satisfied.

When the antenna 200 is in normal operation, the first short-circuit protection circuit 10 and the second short-circuit protection circuit 20 are not activated, and the current flowing through the component 300 has a normal value. Under such circumstance, the eighth transistor BJT6 is cut off because the eighth trigger condition is not satisfied with the detection voltage Vs provided by the current mirror 32. For illustrative purpose, it is assumed that the eighth transistor BJT6 is an NPN-type BJT. When the antenna 200 is able to operate normally, the detection voltage Vs established at the control terminal B6 of the eighth transistor BJT6 cannot be sufficiently larger than the potential of the second terminal E6 of the eighth transistor BJT6. The above-mentioned insufficient voltage difference results in a reverse-biased V_{BE6}, and the eighth transistor BJT6 is cut off, thereby maintaining the potential V_{C6} on the first terminal C6 of the eighth transistor BJT6 at the first potential Vp (such as a high voltage of 3.3V). When detecting the potential V_{C6} equal to the first potential Vp, the GNSS module 34 determines that the antenna 200 is in normal operation.

When the antenna 200 is in a short-to-battery or a short-to-ground situation, the first short circuit protection circuit 10 or the second short circuit protection circuit 20 can provide short circuit protection. Under such circumstance, the current flowing through the component 300 is essentially 0, and the eighth transistor BJT6 is turned on because the eighth trigger condition is satisfied with the detection voltage Vs provided by the current mirror 32. For illustrative purpose, it is assumed that the eighth transistor BJT6 is an NPN-type BJT. When the antenna 200 in a short-to-battery or a short-to-ground situation, the detection voltage Vs established at the control terminal B6 of the eighth transistor BJT6 is sufficiently larger than the potential of the second terminal E6 of the eighth transistor BJT6, thereby resulting in a forward-biased V_{BE6}. Under such circumstance, the eighth transistor BJT6 is turned on, thereby forcibly pulling the potential V_{C6} on the first terminal C6 of the eighth transistor BJT6 to the ground potential GND (such as a low potential of 0V). When detecting the potential V_{C6} equal to the low potential, the GNSS module 34 determines that the antenna 200 is unable to operate normally.

In conclusion, the present invention provides a short-circuit protection system 100 capable of providing real-time monitoring and protection, wherein the first short-circuit protection circuit 10 can provide short-to power protection, the second short-circuit protection circuit 20 can provide short-to-ground protection, and the antenna status detection circuit 30 can detect the operating status of the antenna 200. In the short-circuit protection system 100 of the present invention, the first short-circuit protection circuit 10, the second short-circuit protection circuit 20 and the antenna status detection circuit 30 may be implemented by hardware. Therefore, short-circuit condition can be detected on a real-time basis without relying on the operation of software to protect the components in the circuits, thereby ensuring stable operation of the antenna 200.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A short-circuit protection system for providing short-circuit protection between an antenna and a component, comprising:
a first short-circuit protection circuit, comprising:
a first transistor which includes:
a first terminal;
a second terminal coupled to a ground potential; and
a control terminal coupled to the antenna;
a second transistor which includes:
a first terminal coupled to the antenna;
a second terminal; and
a control terminal coupled to the first terminal of the first transistor; and
a third transistor which includes:
a first terminal coupled to the antenna;
a second terminal coupled to the component; and
a control terminal coupled to the second terminal of the second transistor.

2. The short-circuit protection system of claim 1, wherein:
the first transistor is turned on when the antenna short-circuited to a positive voltage causes an overvoltage on the control terminal of the first transistor, the first terminal of the second transistor and the first terminal of the third transistor;
the second transistor is turned on when the turned-on first transistor transmits energy associated with the overvoltage to the control terminal of the second transistor; and
the third transistor is turned off when the turned-on second transistor transmits the energy associated with the overvoltage to the control terminal of the third transistor, thereby cutting off energy transfer path from the overvoltage to the component.

3. The short-circuit protection system of claim 1, wherein:
the first transistor is an NPN-type bipolar junction transistor; and
each of the second transistor and the third transistor is a P-channel metal-oxide-semiconductor field-effect transistor.

4. The short-circuit protection system of claim 1, further comprising:
a second short-circuit protection circuit, comprising:
a fourth transistor which includes:
a first terminal;
a second terminal coupled to the ground potential; and
a control terminal;
a fifth transistor which includes:
a first terminal;
a second terminal coupled to the ground potential; and
a control terminal coupled to the first terminal of the fourth transistor;
a sixth transistor which includes:
a first terminal;
a second terminal coupled to the ground potential; and
a control terminal coupled to the first terminal of the fifth transistor;
a seventh transistor which includes:
a first terminal coupled to the antenna;
a second terminal coupled to the component; and
a control terminal coupled to the first terminal of the sixth transistor;
a Schottky diode which includes:
an anode coupled to the control terminal of the fourth transistor; and
a cathode coupled to the antenna;
a first power source configured to provide a positive voltage to the control terminal of the fourth transistor; and
a second power source configured to provide the positive voltage to the control terminal of the fifth transistor.

5. The short-circuit protection system of claim 4, wherein:
when the antenna short-circuited to the ground potential causes an overcurrent, the second terminal of the fourth transistor is pulled to the ground voltage to cut off the fourth transistor;
when the fourth transistor is cut off, the second power source provides the positive voltage at the control terminal of the fifth transistor, so as to turn on the fifth transistor;
the sixth transistor is cut off when the control terminal of the sixth transistor is pulled to the ground potential via the turned-on fifth transistor;
when the sixth transistor is cut off, voltage difference between the control terminal and the second terminal of the seventh transistor does not satisfy a trigger condition, and the seventh transistor is cut off, thereby cutting off energy transfer path from the overcurrent to the component.

6. The short-circuit protection system of claim 4, wherein:
each of the fourth transistor, the fifth transistor and the sixth transistor is an NPN-type bipolar junction transistor; and
the seventh transistor is a PNP-type bipolar junction transistor.

7. The short-circuit protection system of claim 1, further comprising:
an antenna status detection circuit, comprising:
a current mirror configured to detect current flowing through the component for providing a detection voltage;
an eighth transistor which includes:
a first terminal coupled to a first potential different from the ground potential;
a second terminal coupled to the ground potential; and
a control terminal coupled to the current mirror for receiving the detection voltage; and
a global navigation satellite system (GNSS) module coupled to the first terminal of the eighth transistor and configured to detect an operational status of the antenna based on potential at the first terminal of the eighth transistor.

8. The short-circuit protection system of claim 7, wherein the eighth transistor is an NPN-type bipolar junction transistor.

9. The short-circuit protection system of claim 7, wherein the current mirror comprises:
a ninth transistor which includes:
a first terminal coupled to the ground potential;
a second terminal coupled to a first end of the antenna; and
a control terminal; and
a tenth transistor which includes:
a first terminal for outputting the detection voltage;
a second terminal coupled to a second end of the antenna; and
a control terminal coupled to the control terminal of the ninth transistor.

10. The short-circuit protection system of claim 9, wherein each of the ninth transistor and the tenth transistor is a PNP-type bipolar junction transistor.

11. The short-circuit protection system of claim 7, wherein:
when the antenna is able to function normally, the eighth transistor is cut off by the detection voltage provided by the current mirror, thereby maintaining the first terminal of the eighth transistor at the first potential.

12. The short-circuit protection system of claim 11, wherein:
the antenna status detection circuit is configured to determine that the antenna is able to function normally when detecting that the first terminal of the eighth transistor is at the first potential.

13. The short-circuit protection system of claim 7, wherein:
when the antenna is short-circuited to a positive voltage positive voltage or the ground potential, the eighth transistor is turned on by the detection voltage provided by the current mirror, thereby pulling the first terminal of the eighth transistor to the ground potential.

14. The short-circuit protection system of claim 13, wherein:
the antenna status detection circuit is configured to determine that the antenna is unable to function normally when detecting that the first terminal of the eighth transistor is at the ground potential.
